(19) United States
(12) Patent Application Publication
(10) Pub. No.: US 2016/0285943 A1
(43) Pub. Date: Sep. 29, 2016

(54) CLOUD OPERATION RESOURCE DYNAMIC ALLOCATION SYSTEM AND METHOD THEREOF

(71) Applicant: INDUSTRIAL TECHNOLOGY RESEARCH INSTITUTE, Hsinchu (TW)

(72) Inventors: Hui-Kai Su, Chiayi County (TW); Chang-Ming Lee, Chiayi County (TW); Ming-Ta Yang, New Taipei City (TW); Cheng-Shong Wu, Taoyuan City (TW)

(21) Appl. No.: 14/826,761

(22) Filed: Aug. 14, 2015

(30) Foreign Application Priority Data
Mar. 25, 2015 (TW) 104109625

(51) Int. Cl. H04L 29/06; H04L 12/911

(52) U.S. Cl. CPC H04L 65/607; H04L 47/70; H04L 65/601

(57) ABSTRACT

A cloud operation resource dynamic allocation system and method are provided. The cloud operation resource dynamic allocation system includes multiple transcoders and a transcoding proxy. Each transcoder is selectively in an active state or an inactive state. The transcoding proxy couples to at least one transcoder which is in the active state. The transcoding proxy receives a streaming data, and determines at least one estimated transcoding time according to at least one multimedia feature of the streaming data. And the transcoding proxy determines a target transcoder which can transcode the streaming data at the earliest such that to appoint the target transcoder for transcoding the streaming data.

### CROSS-REFERENCE TO RELATED APPLICATION

This application claims the priority benefits of Taiwan application serial no. 104109625, filed on Mar. 25, 2015. The entirety of each of the above-mentioned patent applications is hereby incorporated by reference herein and made a part of specification.

### TECHNICAL FIELD

The disclosure relates to a cloud operation resource dynamic allocation system and method.

### BACKGROUND

In recent years, with the development of the internet technology, the cloud computing technology and the smart multimedia broadcast platform, etc. The user can watch video entertainment content anytime, anywhere on a variety of devices. Thus the multimedia service provider will face the issue how to satisfy the needs for streaming broadcast at the same time on various heterogeneous broadcast platforms.

Through a real-time transcoding multimedia streaming service to transcode/encode video streams into a suitable coding format, in order to provide a suitable multimedia streaming service on the heterogeneous broadcast platform. But the real-time transcoding requires a lot of computing power, it's not easy to implement on a terminal device, such as smart phone or tablet PC. Therefore, the transcoding processes are transferred to a cloud computing center based on the cloud computing technology.

Since real-time transcoding multimedia streaming require a lot of computing resources temporarily. Most of the devices use multi-parallel processing or the transcoding hardware to speed up transcoding. However, whether it is multi-parallel processing or the transcoding hardware all can not dynamically adjust the transcoding resources. So that the transcoding resources are not as flexible as well, and caused to the relatively high cost of transcoding.

### SUMMARY

An embodiment of the present disclosure provides a cloud operation resource dynamic allocation system. The cloud operation resource dynamic allocation system is adapted for transcoding a streaming data from a first coding bit rate into a second coding bit rate. The cloud operation resource dynamic allocation system includes a plurality of transcoders and a transcoding proxy. Each of the plurality of transcoders is selectively in an active state or in an inactive state. The transcoding proxy couples to at least one of the plurality of transcoders which is in the active state. The transcoding proxy receives the streaming data and determines at least one estimated transcoding time of the at least one of the plurality of transcoders which is in the active state according to at least one multimedia feature of the streaming data. The transcoding proxy determines a target transcoder which transcodes the streaming data at the earliest and appoints the target transcoder for transcoding the streaming data.

An embodiment of the present disclosure provides a cloud operation resource dynamic allocation method. The cloud operation resource dynamic allocation method is adapted for the cloud operation resource dynamic allocation system. The cloud operation resource dynamic allocation system includes a plurality of transcoders and a transcoding proxy. Each of the plurality of transcoders is selectively in an active state or in an inactive state. The transcoding proxy couples to at least one of the plurality of transcoders which is in the active state. The cloud operation resource dynamic allocation system is adapted for transcoding a streaming data from a first coding bit rate into a second coding bit rate. The method includes following steps. The transcoding proxy receives the streaming data. The transcoding proxy determines at least one estimated transcoding time of the at least one of the plurality of transcoders which is in the active state according to at least one multimedia feature of the streaming data. The transcoding proxy determines a target transcoder which transcodes the streaming data at the earliest according to the at least one estimated transcoding time. The transcoding proxy appoints the target transcoder for transcoding the streaming data.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic diagram of a cloud operation resource dynamic allocation system according to an embodiment of the disclosure.

FIG. 1B is a schematic diagram of a cloud operation resource dynamic allocation system according to another embodiment of the disclosure.

FIG. 2 is a schematic flowchart of the cloud operation resource dynamic allocation method to an embodiment of the disclosure.

FIG. 3 is a detailed schematic flowchart of step S202 in FIG. 2 to an embodiment of the disclosure.

FIG. 4 is a schematic flowchart of the cloud operation resource dynamic allocation method to the second embodiment of the disclosure.

FIG. 5 is a schematic diagram of a cloud operation resource dynamic allocation system which adds the cloud transcoding resources according to an embodiment of the disclosure.

FIG. 6 is a schematic flowchart of the cloud operation resource dynamic allocation method to the third embodiment of the disclosure.

FIG. 7 is a schematic diagram of a cloud operation resource dynamic allocation system which releases the cloud transcoding resources according to an embodiment of the disclosure.

### DETAILED DESCRIPTION OF DISCLOSED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Exemplary embodiments of the present disclosure may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

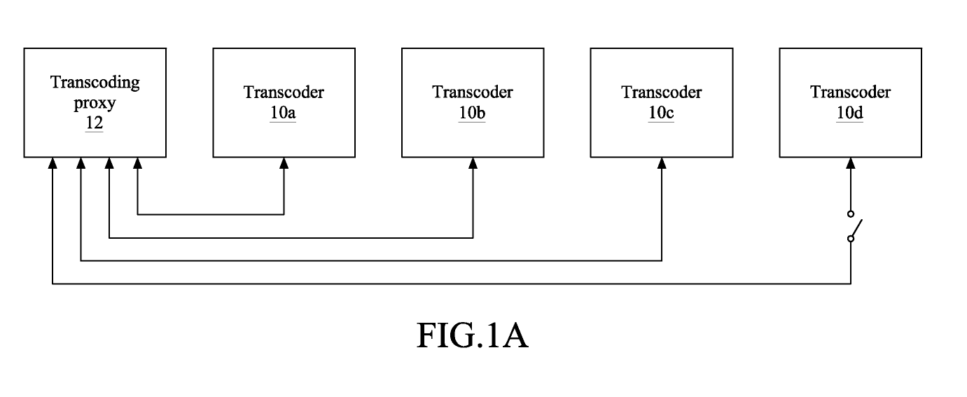

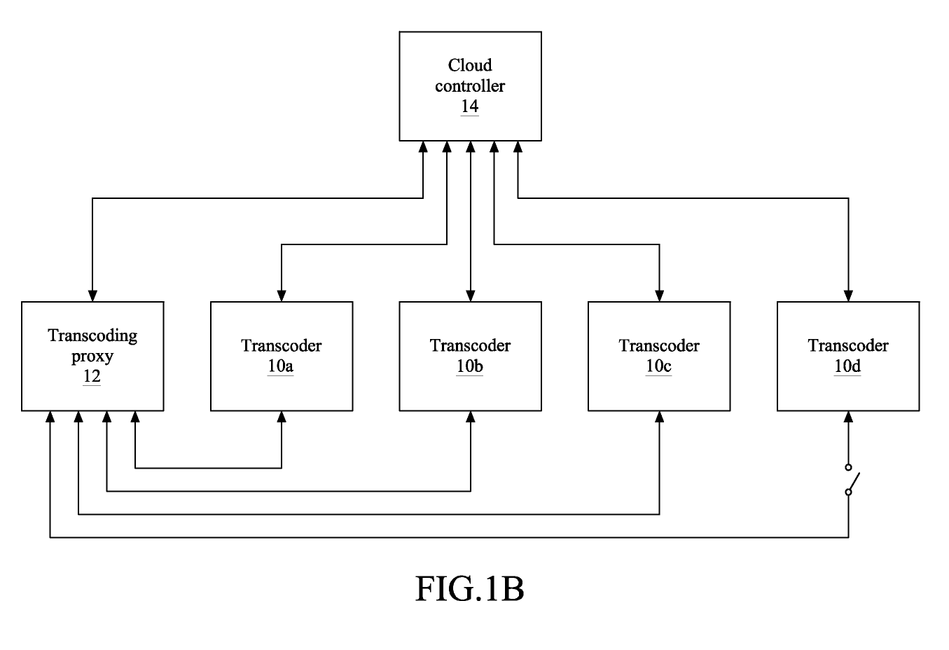

FIG. 1A is a schematic diagram of a cloud operation resource dynamic allocation system according to an embodiment of the disclosure. Referring to FIG. 1A, in the present embodiment, the cloud operation resource dynamic allocation system 1 is adapted for transcoding a streaming data from a first coding bit rate into a second coding bit rate. The cloud operation resource dynamic allocation system 1 includes a plurality of transcoders 10a˜10d and a transcoding proxy 12. Each of the plurality of transcoders 10a˜10d is selectively in an active state or in an inactive state. The embodiment shown in FIG. 1A, the transcoders 10a˜10c are in the active state, and the transcoder 10d is in the inactive state. The transcoding proxy 12 couples to the plurality of transcoders 10a 10c which are in the active state.

It is to be noted that the expression “couple” in the exemplary embodiments of the present disclosure may be implemented as physical line connection or implemented as wireless connection, but the disclosure is not limited thereto. In addition, the cloud operation resource dynamic allocation system 1 as shown in FIG. 1A has a fixed number of the transcoders 10a˜10d, but the disclosure is not limited to the number of the transcoders. In practice, the streaming data is a kind of multimedia fragment, and the streaming data comprises at least one of group of pictures (GOP). The type of the streaming data is, but is not limited to, at least one of H.264, H.264/SVC, H.264/AVC, MPEG4, Flash, QuickTime, Windows Media and RealVideo, etc. In addition, the cloud operation resource dynamic allocation system 1 in the exemplary embodiments of the present disclosure may be regarded as a server system. The server system may be configured with a plurality of nodes. The plurality of transcoders 10a˜10d and the transcoding proxy 12 may be embedded or implemented in the plurality of nodes. The plurality of nodes may be implemented in a physical machine (PM) or in a virtual machine (VM), but the disclosure is not limited thereto. The aforementioned cloud operation resource dynamic allocation system 1 proposed by the present disclosure is described in details below.

Each of the transcoders 10a˜10d is selectively in an active state or in an inactive state. The transcoders 10a˜10c which are in the active state would transcode the bitrate of the streaming data. The transcoders 10a˜10c which are in the active state would transcode the streaming data from a first coding bit rate into a second coding bit rate (e.g., transcoding the streaming data from 13 Mbps to 3 Mbps or transcoding the streaming data from 13 Mbps to 1 Mbps). The embodiment of the disclosure is not limited to the number of the transcoders, in other words, even if only one transcoder which is in the active state would also apply to the cloud operation resource dynamic allocation system 1 of the present disclosure. On the other hand, the transcoder 10d which is in inactive state would not transcode the streaming data. The embodiment of the disclosure is not limited to the actual bitrate of the first coding bit rate and the second coding bit rate. In addition, the inactive state includes, but is not limited to, one of sleep state, hibernate state, shut down state or other power-saving state thereof

The transcoding proxy 12 receives the streaming data and determines a plurality of estimated transcoding time of the transcoders 10a˜10c which are in the active state according to at least one multimedia feature of the streaming data. That is the transcoding proxy 12 determines a first estimated transcoding time of the transcoders 10a, a second estimated transcoding time of the transcoders 10b and a third estimated transcoding time of the transcoders 10c according to at least one multimedia feature of the streaming data respectively. In this way, the transcoding proxy 12 determines a target transcoder which transcodes the streaming data at the earliest according to the above-mentioned first, second, and third estimated transcoding times and the current working conditions of the transcoders 10a˜10c. Wherein the estimated transcoding time of each transcoder is corresponding to the transcoding rate of each transcoder which transcodes the streaming data.

In practice, the at least one multimedia feature is, but is not limited to, at least one of the quantization parameter (QP), the number of frames, the video types or the resolution of the streaming data thereof. Examples of the video types of the streaming data include drama, sports, news, variety, etc, but the disclosure is not limited thereto. In general, the higher quantization parameter of the streaming data for transcoding will require a longer estimated transcoding time, the more number of frames of the streaming data for transcoding will require a longer estimated transcoding time, the larger change per unit time of the video types of the streaming data will require a longer estimated transcoding time, the higher resolution of the streaming data for transcoding will require a longer estimated transcoding time.

In operation, the transcoding proxy 12 receives multimedia information which is composed by a plurality of the streaming data. When the transcoding proxy 12 receives multimedia information, the transcoding proxy 12 divides the multimedia information into a plurality of streaming data (i.e., a plurality of multimedia fragments) for subsequent process procedure. In addition, the transcoding proxy 12 may further determine a transcoding class according to the at least one multimedia feature of the streaming data and determine the estimated transcoding time, respectively, for transcoding the streaming data by the transcoders 10a˜10c which are in the active state according to the transcoding class. Wherein the transcoding class is corresponding to the computational complexity for transcoding the streaming data from the first coding bit rate into the second coding bit rate.

For example, the transcoding proxy 12 transcodes the bitrate of the i^{th} streaming data from T Mpbs (i.e., the first coding bit rate) into F Mbps(i.e., the second coding bit rate). The transcoding proxy 12 has determined the transcoding class of the streaming data is the K-class and calculated the estimated transcoding time R_{j,k}^{T,F} of the j^{th} transcoder which transcodes the i^{th} streaming data. If the j^{th} transcoder no workload at time tⁱ, the transcoding proxy 12 will determine the estimated finish time fⱼⁱ=tⁱ+R_{j,k}^{T,F} for transcoding thei streaming data by the j^{th} transcoder. On the other hand, if the j^{th} transcoder estimates to finish the current work at time fᵢ, then the transcoding proxy 12 will determine the estimated finish time fⱼⁱ=fⱼ+R_{j,k}^{T,F} for transcoding the i^{th} streaming data by the j^{th} transcoder. In this way, the transcoding proxy 12 determines the estimated finish time fⱼⁱ=max(tⁱ, fⱼ)+R_{j,k}^{T,F} for transcoding the i^{th} streaming data by the j^{th} transcoder according to the estimated transcoding time R_{j,k}^{T,F} of the j^{th} transcoder which transcodes the i^{th} streaming data and the current working conditions of the j^{th} transcoder. The transcoding proxy 12 determines a target transcoder which transcodes the i^{th} streaming data at the earliest by using a formula listed below.

$$\hat{j} = arg {min}_{j} {f}_{j}^{i}$$

Wherein ĵ is the target transcoder among the plurality of transcoders which transcodes the i^{th} streaming data at the earliest time, fⱼⁱ is the estimated finish time for transcoding the i^{th} streaming data by the j^{th} transcoder. (i.e.,

$${f}_{\hat{j}}^{i} = {min}_{j} {f}_{j}^{i}$$

is the estimated finish time of the target transcoder which transcodes the i^{th} streaming data).

In addition, the cloud operation resource dynamic allocation system 1 in the exemplary embodiments of the present disclosure may further control the transcoders 10a˜10d in the active state or in the inactive state, respectively. FIG. 1B is a schematic diagram of a cloud operation resource dynamic allocation system 1′ according to another embodiment of the disclosure. Referring to FIG. 1B, in the present embodiment, the cloud operation resource dynamic allocation system 1′ includes a plurality of transcoders 10a˜10d, a transcoding proxy 12 and a cloud controller 14. The functions and the connections of the transcoders 10a˜10d and the transcoding proxy 12 in the cloud operation resource dynamic allocation system 1′ of the present embodiment are described in detail as above, thus related description is omitted hereinafter.

The cloud operation resource dynamic allocation system 1′ in the present embodiment further comprise a cloud controller 14. The cloud controller 14 couples to the transcoders 10a˜10d and the transcoding proxy 12. The cloud controller 14 respectively controls the transcoders 10a˜10d in the active state or in the inactive state according the instruction of the transcoding proxy 12. In other words, each of the transcoders 10a˜10d is controlled by the cloud controller 14, and is selectively in the active state or in the inactive state.

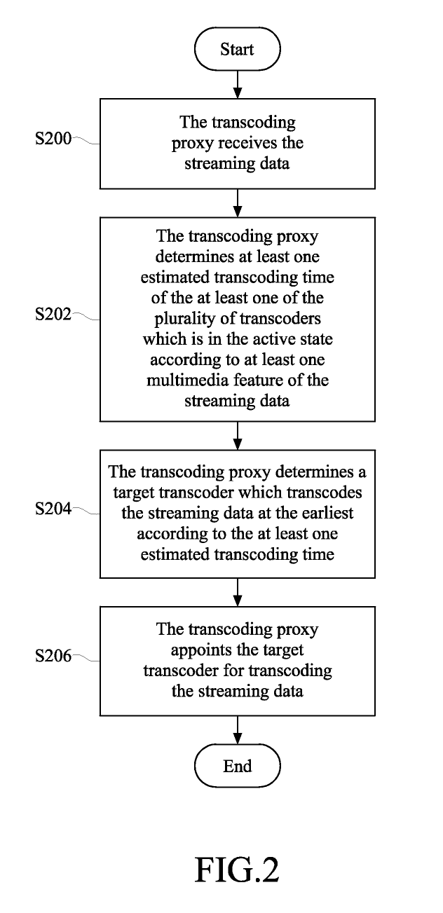

In order to more describe the functions and the operations of the cloud operation resource dynamic allocation system 1 or 1′. FIG. 2 is a schematic flowchart of the cloud operation resource dynamic allocation method to an embodiment of the disclosure. Referring to FIG. 2, in the present embodiment, the cloud operation resource dynamic allocation method is adapted for the cloud operation resource dynamic allocation system 1 in FIG. 1A and the cloud operation resource dynamic allocation system 1′ in FIG. 1B. The cloud operation resource dynamic allocation method in the present embodiment is provided below with reference to the cloud operation resource dynamic allocation system 1′ in FIG. 1B. The steps of the cloud operation resource dynamic allocation method are described below.

In step S200, the transcoding proxy 12 receives the streaming data. In step

S202, the transcoding proxy 12 determines at least one estimated transcoding time of the at least one of the plurality of transcoders which is in the active state according to at least one multimedia feature of the streaming data. In step S204, the transcoding proxy 12 determines a target transcoder which transcodes the streaming data at the earliest according to the at least one estimated transcoding time. In step S206, the transcoding proxy 12 appoints the target transcoder for transcoding the streaming data according to the result of step S204.

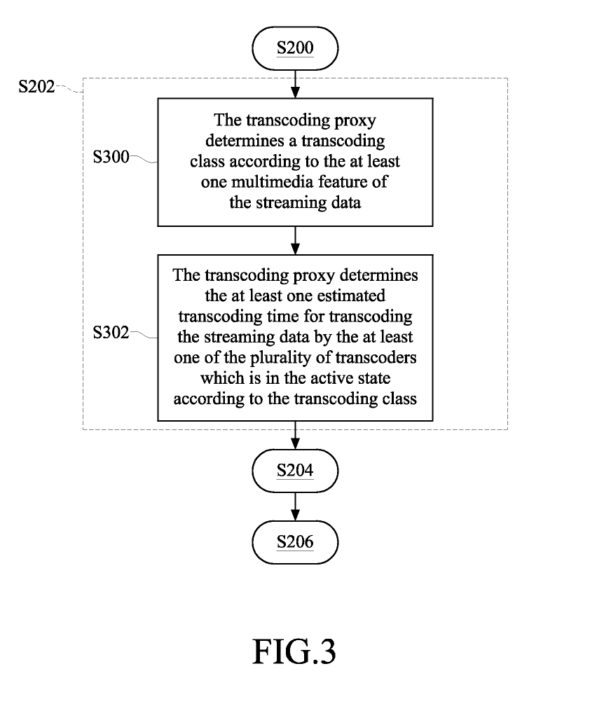

Please referring to FIG. 1B, FIG. 2 and FIG. 3, FIG. 3 is a detailed schematic flowchart of step S202 in FIG. 2 to an embodiment of the disclosure. Referring to FIG. 3, in step of the transcoding proxy 12 determines at least one estimated transcoding time of the at least one of the plurality of transcoders which is in the active state according to at least one multimedia feature of the streaming data (i.e., step S202) may further include the following detailed steps and description . In step S300, the transcoding proxy 12 determines a transcoding class according to the at least one multimedia feature of the streaming data. Wherein the transcoding class is corresponding to the computational complexity for transcoding the streaming data from the first coding bit rate into the second coding bit rate. In step S302, the transcoding proxy 12 determines the at least one estimated transcoding time for transcoding the streaming data by the at least one of the plurality of transcoders which is in the active state (e.g., transcoders 10a˜10c ) according to the transcoding class.

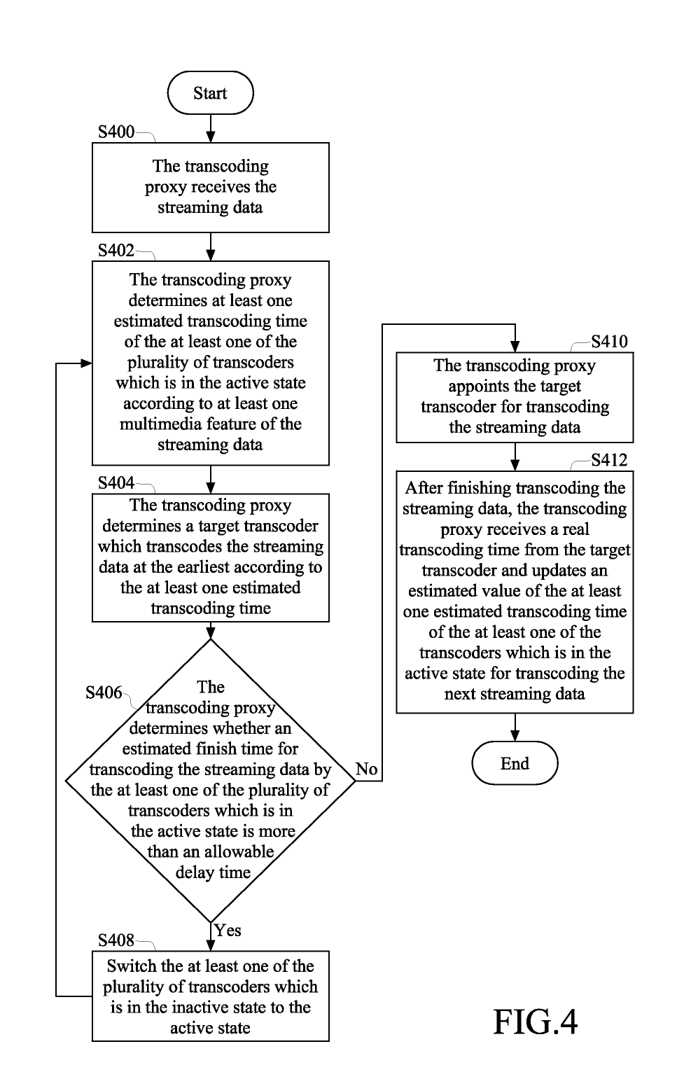

Please referring to FIG. 1B and FIG. 4. FIG. 4 is a schematic flowchart of the cloud operation resource dynamic allocation method to the second embodiment of the disclosure. First mention that, the steps S200˜S204 in FIG. 2 are the same with the steps S400˜S404 in FIG. 4, thus related description is omitted hereinafter. In addition, the exemplary embodiment in FIG. 4 has at least one transcoder which is in the inactive state. Referring to FIG. 4, in step S406, the transcoding proxy 12 determines whether an estimated finish time for transcoding the streaming data by the at least one of the plurality of transcoders which is in the active state is more than an allowable delay time, and selectively switches the at least one of the plurality of transcoders which is in the inactive state to the active state. The step S406 by using a formula listed below.

fⱼⁱ−tⁱ>Dₘₐₓ, ∀j for all j

Wherein D ₘₐₓ is the allowable delay time of the cloud operation resource dynamic allocation system 1′, fⱼⁱ is the estimated finish time for transcoding the i^{th} streaming data by the j^{th} transcoder.

The transcoding proxy 12 determines the estimated finish time for transcoding the streaming data by the at least one of the plurality of transcoders which is in the active state is more than the allowable delay time, then the method proceeds to step S408. If the transcoding proxy 12 determines the estimated finish time for transcoding the streaming data by the at least one of the plurality of transcoders which is in the active state is not more than the allowable delay time, then the method proceeds to step S410. The exemplary embodiment of the disclosure is not limited to the actual time of the allowable delay time. The skilled person in the art can learn from the present disclosure and improve the allowable delay time appropriately. Wherein, in step S406, the transcoding proxy 12 determines whether the estimated finish time for transcoding the streaming data by each of the transcoders which is in the active state (including the target transcoder) is more than the allowable delay time.

In step S408, the transcoding proxy 12 instructs the cloud controller 14 to switch the at least one of the plurality of transcoders which is in the inactive state to the active state. Then the method proceeds back to step S402, the transcoding proxy 12 determines at least one estimated transcoding time of the at least one of the plurality of transcoders which is in the active state according to at least one multimedia feature of the streaming data, and the following steps.

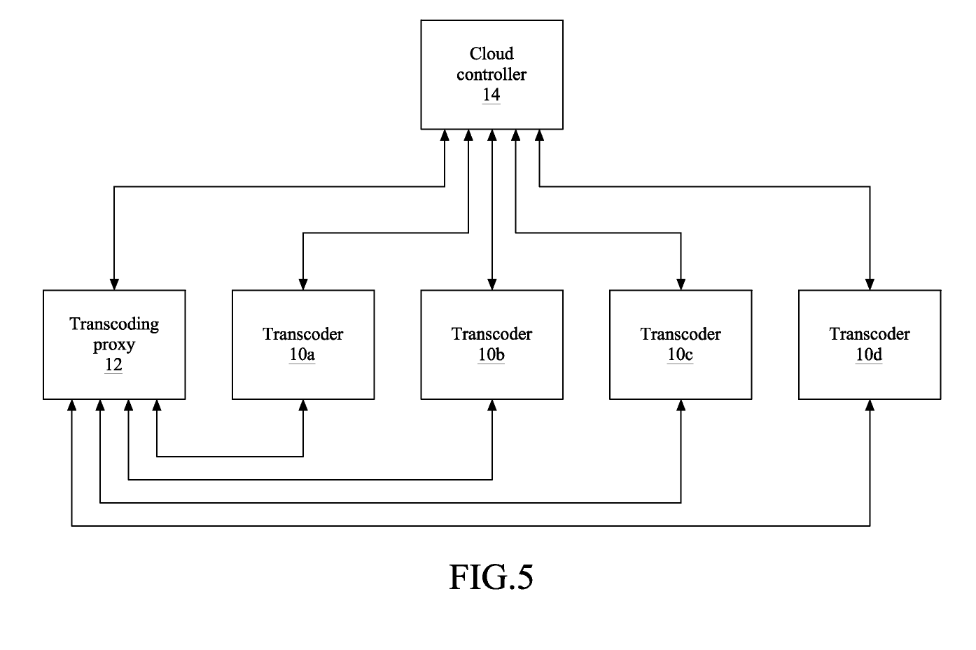

To more clearly describe the step S408, referring to FIG. 1B and FIG. 5, FIG. 5 is a schematic diagram of a cloud operation resource dynamic allocation system which adds the cloud transcoding resources according to an embodiment of the disclosure. Referring to the embodiment depicted in FIG. 1B, the transcoder 10d is in the inactive state and idling in the cloud operation resource dynamic allocation system 1′. When the transcoding proxy 12 determines the estimated finish time for transcoding the streaming data by each of the transcoders 10a˜10c which is in the active state is more than the allowable delay time, then switches the transcoder 10d which is in the inactive state to the active state. So that, the transcoding proxy 12 couples to the plurality of transcoders 10a˜10d (as shown in FIG. 5) and proceeds back to step S402.

Please referring to FIG. 4, in step S410, the transcoding proxy 12 appoints the target transcoder for transcoding the streaming data. In step S412, after finishing transcoding the streaming data, the transcoding proxy 12 receives a real transcoding time from the target transcoder and updates an estimated value of the at least one estimated transcoding time of the at least one of the transcoders which is in the active state for transcoding the next streaming data (i.e., the i^{th}+1 streaming data). In practice, the transcoding proxy 12 respectively updates the estimated value of the estimated transcoding time of each of the transcoders which is in the active state for transcoding the next streaming data using exponential smoothing method. The step S412 by using a formula listed below.

R_{j,k}^{T,F}=α*R_{j,k}^{T,F}+(1−α)*R_{j,k}^{T,F}

Wherein a is a fixed value between 0 and 1. The recommendatory value of α is between 0.7 and 0.9.

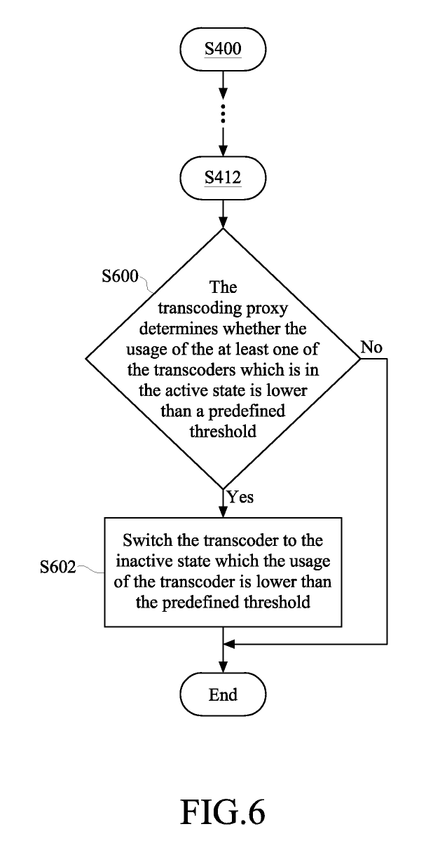

Please referring to FIG. 1B, FIG. 4 and FIG. 6. FIG. 6 is a schematic flowchart of the cloud operation resource dynamic allocation method to the third embodiment of the disclosure. First mention that, the steps S400˜S412 in FIG. 6 are the same with the steps S400˜S412 in FIG. 4, thus related description is omitted hereinafter. Referring to FIG. 6, in step S600, the transcoding proxy 12 determines whether the usage of the at least one of the transcoders which is in the active state is lower than a predefined threshold. If the usage of the at least one of the transcoders is lower than the predefined threshold then selectively switches the at least one of the transcoder which is in the active state to the inactive state. In general, the usage of the transcoder is the working time of the transcoder divided by the total turn-on time of the transcoder. The embodiment of the disclosure is not limited to the actual value of the predefined threshold. The skilled person in the art can learn from the present disclosure and improve the predefined threshold appropriately.

If the transcoding proxy 12 determines the usage of the at least one of the transcoders which is in the active state is lower than the predefined threshold, then the method proceeds to step S602. If the transcoding proxy 12 determines the usages of the transcoders which are in the active state are all higher than the predefined threshold, then the method skips step S602 and the end of the cloud operation resource dynamic allocation method. In step S602, the transcoding proxy 12 switches the transcoder to the inactive state which the usage of the transcoder is lower than the predefined threshold (i.e., release the transcoder resources which the usage of the transcoder is lower than the predefined threshold).

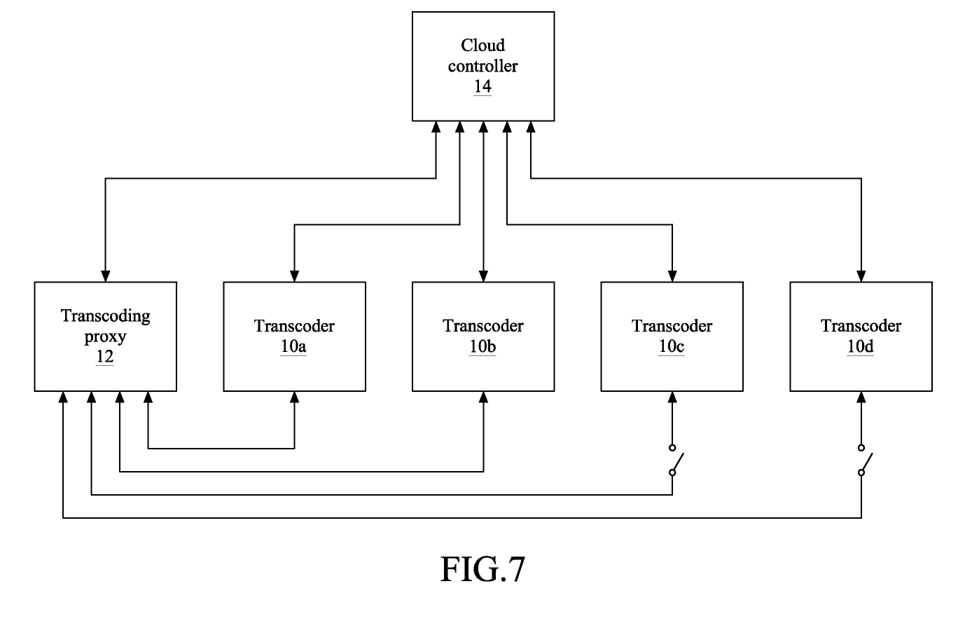

In order to more describe the process in step S602, please referring to FIG. 1B and FIG. 7. FIG. 7 is a schematic diagram of a cloud operation resource dynamic allocation system which releases the cloud transcoding resources according to an embodiment of the disclosure. Referring to the embodiment depicted in FIG. 1B, when the transcoding proxy 12 determines the usage of the transcoder 10c which is in the active state is lower than the predefined threshold, then switches the transcoder 10c which is in the active state to the inactive state (as shown in FIG. 7).

In practice, after the target transcoder finished transcoding the streaming data, the streaming data having the second coding bit rate, the streaming data may stored in the storage medium of cloud operation resource dynamic allocation system 1′. The storage medium may be a MPEG-Dash Formatting device, but the disclosure is not limited thereto. Therefor, the user terminal may communication couple to the storage medium to read and view the streaming data having the second coding bit rate.

The embodiments of the disclosure provide a cloud operation resource dynamic allocation system and method. The cloud operation resource dynamic allocation system and method predicts a target transcoder which transcodes the streaming data at the earliest according to at least one multimedia feature of the streaming data, the working status of the cloud transcoders and the speed of the transcoding by using earliest finishing time first algorithm to achieve a better allocation of resources in the cloud transcoders. In this way, the cloud operation resource dynamic allocation system and method of the disclosure may add the cloud transcoding resources when the real-time streaming transcoding may not satisfy the limit of the allowable delay time (i.e., switch the transcoder which is in the inactive state to the active state).

In addition, the cloud operation resource dynamic allocation system and method determine when the usage of one of the transcoders which is in the active state is reducing then release the cloud transcoding resources (i.e., switch the transcoder which is in the active state to the inactive state). In this way, the cloud operation resource dynamic allocation system and method of the disclosure may achieve the real-time streaming transcoding and rarely have to use cloud transcoding resources.

In addition, the various illustrative transcoding proxy, transcoders, and cloud controller described with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A cloud operation resource dynamic allocation system, the cloud operation resource dynamic allocation system adapted for transcoding a streaming data from a first coding bit rate into a second coding bit rate, the system comprising:
a plurality of transcoders, each of the plurality of transcoders is selectively in an active state or in an inactive state; and
a transcoding proxy, coupling to at least one of the plurality of transcoders which is in the active state, the transcoding proxy receives the streaming data and determines at least one estimated transcoding time of the at least one of the plurality of transcoders which is in the active state according to at least one multimedia feature of the streaming data, the transcoding proxy determines a target transcoder which transcodes the streaming data at the earliest and appoints the target transcoder for transcoding the streaming data.

2. The cloud operation resource dynamic allocation system as claimed in claim 1, wherein the transcoding proxy determines the at least one estimated transcoding time of the at least one of the plurality of transcoders which is in the active state according to the at least one multimedia feature of the streaming data, the transcoding proxy further comprising :
the transcoding proxy determines a transcoding class according to the at least one multimedia feature of the streaming data, and determines the at least one estimated transcoding time for transcoding the streaming data by the at least one of the plurality of transcoders which is in the active state according to the transcoding class, wherein the transcoding class is corresponding to the computational complexity for transcoding the streaming data from the first coding bit rate into the second coding bit rate.

3. The cloud operation resource dynamic allocation system as claimed in claim 1, wherein when at least one of the plurality of transcoders which is in the inactive state and after the transcoding proxy determining the at least one estimated transcoding time of the at least one of the plurality of transcoders which is in the active state according to the at least one multimedia feature of the streaming data, the transcoding proxy further determines whether an estimated finish time for transcoding the streaming data by the at least one of the plurality of transcoders which is in the active state is more than an allowable delay time, and selectively switches the at least one of the plurality of transcoders which is in the inactive state to the active state.

4. The cloud operation resource dynamic allocation system as claimed in claim 3, wherein the transcoding proxy further determines the estimated finish time for transcoding the streaming data by the at least one of the plurality of transcoders which is in the active state is more than the allowable delay time, then switches the at least one of the plurality of transcoders which is in the inactive state to the active state, and the transcoding proxy executes the following procedures after the process of determining the at least one estimated transcoding time of the at least one of the plurality of transcoders which is in the active state according to the at least one multimedia feature of the streaming data.

5. The cloud operation resource dynamic allocation system as claimed in claim 3, the transcoding proxy determines the estimated finish time for transcoding the streaming data by the at least one of the plurality of transcoders which is in the active state is not more than the allowable delay time, then the transcoding proxy appoints the target transcoder for transcoding the streaming data, after finishing transcoding the streaming data, the transcoding proxy receives a real transcoding time from the target transcoder and updates an estimated value of the at least one estimated transcoding time of the at least one of the plurality of transcoders which is in the active state for transcoding the next streaming data.

6. The cloud operation resource dynamic allocation system as claimed in claim 5, wherein the transcoding proxy updates the estimated value of the at least one estimated transcoding time of the at least one of the plurality of transcoders which is in the active state for transcoding the next streaming data using exponential smoothing method.

7. The cloud operation resource dynamic allocation system as claimed in claim 5, wherein after the transcoding proxy finished updating the estimated value of the at least one estimated transcoding time of the at least one of the plurality of transcoders which is in the active state for transcoding the next streaming data, the transcoding proxy further determines whether the usage of the at least one of the plurality of transcoders which is in the active state is lower than a predefined threshold, and selectively switches the at least one of the plurality of transcoders to the inactive state if the usage of the at least one of the plurality of transcoders is lower than the predefined threshold.

8. The cloud operation resource dynamic allocation system as claimed in claim 1, wherein the at least one multimedia feature comprises at least one of quantization parameter, the number of frames and the video types of the streaming data.

9. The cloud operation resource dynamic allocation system as claimed in claim 1, wherein the streaming data comprises at least one of group of pictures (GOP).

10. The cloud operation resource dynamic allocation system as claimed in claim 1, wherein the system further comprises a cloud controller, coupling to the plurality of transcoders and the transcoding proxy, the cloud controller respectively controls the plurality of transcoders in the active state or in the inactive state according the instruction of the transcoding proxy.

11. A cloud operation resource dynamic allocation method for a cloud operation resource dynamic allocation system, the cloud operation resource dynamic allocation system comprises a plurality of transcoders and a transcoding proxy, wherein each of the plurality of transcoders is selectively in an active state or in an inactive state, the transcoding proxy couples to at least one of the plurality of transcoders which is in the active state, the cloud operation resource dynamic allocation system adapted for transcoding a streaming data from a first coding bit rate into a second coding bit rate, the method comprising:
receiving the streaming data by the transcoding proxy;
determining at least one estimated transcoding time of the at least one of the plurality of transcoders which is in the active state according to at least one multimedia feature of the streaming data by the transcoding proxy;
determining a target transcoder which transcodes the streaming data at the earliest according to the at least one estimated transcoding time by the transcoding proxy; and
appointing the target transcoder for transcoding the streaming data by the transcoding proxy.

12. The cloud operation resource dynamic allocation method as claimed in claim 11, wherein the step of determining the at least one estimated transcoding time of the at least one of the plurality of transcoders which is in the active state according to the at least one multimedia feature of the streaming data by the transcoding proxy, further comprising :
determining a transcoding class according to the at least one multimedia feature of the streaming data by the transcoding proxy; and
determining the at least one estimated transcoding time for transcoding the streaming data by the at least one of the plurality of transcoders which is in the active state according to the transcoding class by the transcoding proxy;
wherein the transcoding class is corresponding to the computational complexity for transcoding the streaming data from the first coding bit rate into the second coding bit rate.

13. The cloud operation resource dynamic allocation method as claimed in claim 11, wherein when at least one of the plurality of transcoders which is in the inactive state and after the step of determining the at least one estimated transcoding time of the at least one of the plurality of transcoders which is in the active state according to the at least one multimedia feature of the streaming data by the transcoding proxy, further comprising:
determining whether an estimated finish time for transcoding the streaming data by the at least one of the plurality of transcoders which is in the active state is more than an allowable delay time, and selectively switching the at least one of the plurality of transcoders which is in the inactive state to the active state by the transcoding proxy.

14. The cloud operation resource dynamic allocation method as claimed in claim 13, wherein the step of the determining the estimated finish time for transcoding the streaming data by the at least one of the plurality of transcoders which is in the active state is more than the allowable delay time, then switching the at least one of the plurality of transcoders which is in the inactive state to the active state by the transcoding proxy, and executing the following procedures after the step of determining the at least one estimated transcoding time of the at least one of the plurality of transcoders which is in the active state according to the at least one multimedia feature of the streaming data by the transcoding proxy.

15. The cloud operation resource dynamic allocation method as claimed in claim 13, the step of the determining the estimated finish time for transcoding the streaming data by the at least one of the plurality of transcoders which is in the active state is not more than the allowable delay time, then processing the step of appointing the target transcoder for transcoding the streaming data by the transcoding proxy, comprising:
receiving a real transcoding time from the target transcoder and updating an estimated value of the at least one estimated transcoding time of the at least one of the plurality of transcoders which is in the active state for transcoding the next streaming data after finishing transcoding the streaming data.

16. The cloud operation resource dynamic allocation method as claimed in claim 15, wherein the step of updating the estimated value of the at least one estimated transcoding time of the at least one of the plurality of transcoders which is in the active state for transcoding the next streaming data using exponential smoothing method.

17. The cloud operation resource dynamic allocation method as claimed in claim 15, wherein after finishing the step of updating the estimated value of the at least one estimated transcoding time of the at least one of the plurality of transcoders which is in the active state for transcoding the next streaming data, further comprising:
determining whether the usage of the at least one of the plurality of transcoders which is in the active state is lower than a predefined threshold, and selectively switching the at least one of the plurality of transcoders to the inactive state if the usage of the at least one of the plurality of transcoders is lower than the predefined threshold by the transcoding proxy.

18. The cloud operation resource dynamic allocation method as claimed in claim 11, wherein the at least one multimedia feature comprises at least one of quantization parameter, the number of frames and the video types of the streaming data.

19. The cloud operation resource dynamic allocation method as claimed in claim 11, wherein the streaming data comprises at least one of group of pictures (GOP).

20. The cloud operation resource dynamic allocation method as claimed in claim 11, wherein the system further comprises a cloud controller, coupling to the plurality of transcoders and the transcoding proxy, the cloud controller respectively controls the plurality of transcoders in the active state or in the inactive state according the instruction of the transcoding proxy.
